(19) United States
(12) Patent Application Publication
(10) Pub. No.: US 2018/0295917 A1
(43) Pub. Date: Oct. 18, 2018

(54) Covered Head Support

(71) Applicant: Patty Q. VO, Plano, TX (US)

(72) Inventor: Patty Q. VO, Plano, TX (US)

(21) Appl. No.: 15/487,217

(22) Filed: Apr. 13, 2017

(51) Int. Cl. A42B 1/06; A42B 1/04; A42B 1/00

(52) U.S. Cl. CPC A42B 1/061; B60N 2/4876; A42B 1/006; A42B 1/041

(57) ABSTRACT

A covered head support garment comprising a hood, cap, beanie, or any head-covering article for use by passengers of transportation vehicles is disclosed. The covered head support garment may offer the appearance and functionality of a standard hooded garment, such as a jacket, scarf, or shawl, while simultaneously offering a means for supporting the head of a resting passenger. Additionally, the covered head support garment may provide eye shielding from surrounding light and other passengers, as well as disguise the head-support means.

### TECHNICAL FIELD

The invention set forth in the appended claims relates generally to head support assembly or support devices. More particularly, but without limitation, the present disclosure relates to covered head support devices.

### BACKGROUND

A common complaint of frequent travelers, particularly those who may routinely commute long distances for business purposes, is that it is often difficult to rest or sleep while in transit. Generally, most seats in transportation vehicles, such as airplanes, trains, and automobiles, are not conducive to sleeping. The seats are typically designed to support a passenger in an upright, or sitting, position during their journey. With the exception of seats found in the more expensive, and perhaps cost-prohibitive, cabins of airplanes and trains, such as first class or business class, most seats found in these vehicles are generally not equipped for long periods of rest or sleeping. Typically the seats found in “economy” or “coach” classes offer only a seatback that may slightly recline, and few to no other comfort amenities. In most cases, these seats lack adequate head or neck support, and thus make it very difficult for a passenger to sleep without his or her head nodding forward, lolling from side-to-side, or jerking around during normal movement of the vehicle. Unsurprisingly, passengers, particularly those who travel frequently, often complain of tension, neck pain, headaches, and general fatigue. As a further hindrance to rest, ambient light in the vehicles, whether natural sunlight or artificial light, may interrupt sleep. Additionally, some passengers struggle to relax while their faces are fully exposed to strangers. Therefore, beneficial rest is impaired, if not entirely prevented, under the above-described conditions.

Various types of head support devices have been promoted in an attempt to remedy the problem of poor sleeping conditions on passenger vehicles. Some examples include inflatable cushions, pillows having specifically contoured shapes, and head or chin straps. However, thus far, most of these proposed devices have significant drawbacks, and there remains an outstanding need for providing a comfortable and practical head support solution for traveling passengers. Furthermore, there is a lack of convenient and aesthetically-appealing solutions so as to appeal to the general public.

### BRIEF SUMMARY

This invention pertains to a head support or restraint device, and more particularly to a covered head support device that provides adequate, yet comfortable, head support for a passenger to sleep while in an upright position.

In some embodiments, a head support system may comprise a head covering and a support device. The head covering may comprise a hood, cap, beanie, or any head-covering article. The support device may comprise a cushion member and a securing member. The cushion member may be adapted to be placed in contact with the head of a person. The securing member may be adapted to releasably secure the cushion member to the head covering. The head covering may be sized to extend over the forehead and eyes of the person and to conceal the cushion member.

In some additional embodiments, a head support apparatus may comprise a head covering and a head support assembly. The head support assembly may be configured to be positioned around the head of a passenger and may include a head segment and a support segment. The head segment may also be sized so that a substantial portion of the head segment is covered by the head covering when worn on the passenger and hidden from the view of bystanders. In some embodiments, the head segment may include a first strap portion, a second strap portion, a cushion, and a first portion of a fastening mechanism. The support segment may include a third strap portion and a second portion of the fastening mechanism. The first portion of the fastening mechanism may be configured to be releasably secured to the second portion of the fastening mechanism.

In some further embodiments, a head covering may be sized to cover the entire face of a passenger and thereby provide privacy from fellow passengers.

Objectives, advantages, and a preferred mode of making and using the claimed subject matter may be understood best by reference to the accompanying drawings in conjunction with the following detailed description of illustrative embodiments.

### BRIEF DESCRIPTION OF THE DRAWINGS

FIG. 1 is a schematic diagram of an example embodiment of a hooded head support garment in accordance with this specification;

FIG. 2 is a schematic diagram illustrating additional details that may be associated with some example embodiments of the hooded head support garment of FIG. 1;

FIG. 3 is a schematic diagram of an interior view of a portion of the hooded head support according to some example embodiments;

FIG. 4 is a schematic diagram of an illustrative embodiment of a support assembly for providing support to the head of a user in conjunction with some example embodiments of the hooded head support garment of FIG. 1;

FIG. 5A is a schematic diagram showing portions of the support assembly of FIG. 4, according to some illustrative embodiments;

FIG. 5B is a schematic diagram showing additional portions of the support assembly of FIG. 4, according to some illustrative embodiments;

FIG. 6 is a perspective view of a support assembly for providing support to the head of a user according to some additional example embodiments; and

FIG. 7 is a schematic diagram showing portions of another illustrative embodiment of a support assembly for providing support to the head of a user in conjunction with some embodiments of the hooded head support garment of FIG. 1.

### DESCRIPTION OF EXAMPLE EMBODIMENTS

The following description of example embodiments provides information that enables a person skilled in the art to make and use the subject matter set forth in the appended claims, but may omit certain details already well-known in the art. The following detailed description is, therefore, to be taken as illustrative and not limiting.

The example embodiments may also be described herein with reference to spatial relationships between various elements or to the spatial orientation of various elements depicted in the attached drawings. In general, such relationships or orientation assume a frame of reference consistent with a person who may be a passenger in a transportation vehicle. However, as should be recognized by those skilled in the art, this frame of reference is merely a descriptive expedient rather than a strict prescription.

This invention relates to a covered head support garment that may be suitable for travelers who would like to rest or sleep in a substantially upright, seated position. The covered head support garment may offer the ability to firmly, but gently, retain a passenger's head in contact with the headrest or seatback of a seat or chair, so as to maintain the head in a normal upright position while allowing the passenger to relax and enjoy restful sleep or relaxation. The covered head support garment may also provide eye protection, or shielding, from surrounding light, and other passengers in order for the passenger to more fully relax or sleep.

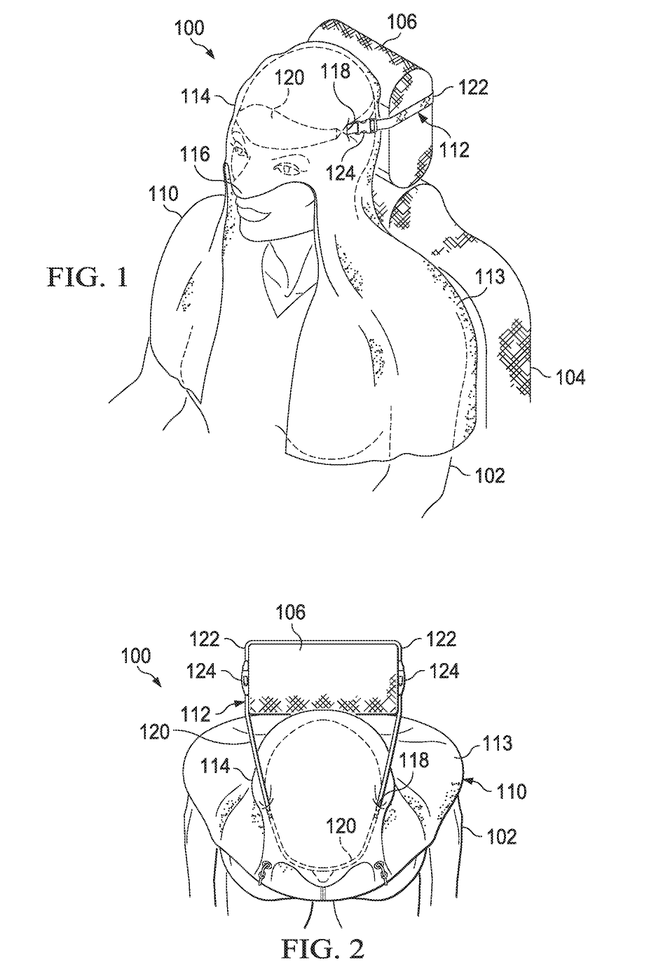

FIG. 1 is a schematic diagram showing details of an illustrative embodiment of a head support system 100 for providing support to the head of a passenger 102 of a transportation vehicle. The passenger 102 may be seated or otherwise positioned in seat 104 having a headrest 106. The passenger 102 may be an adult human passenger, or alternatively may be a child passenger. The head support system 100 may include a head support garment 110 and a head support assembly 112.

In some embodiments, the head support garment 110 may include a body portion 113 and a hood 114. The body portion 113 may be in the form of a scarf, shawl, or other form of garment for generally covering the neck and shoulders of the passenger 102. Alternatively, the body portion 113 may be in the form of a larger garment, such as a jacket, cardigan, blanket, or body wrap, for covering a substantial portion or all of a passenger's torso and/or body. The hood 114 may be of a standard size and shape for extending over and covering a person's head, such as the head of passenger 102. In addition to a typical hood of a garment, the hood 114 may be in the form of a cap, beanie, or any other head-covering article. In some embodiments, the hood 114 may also include a shade 116, which may include a more pronounced portion of the front of the hood 114 that is sized for extending forward and downwards over the forehead and portion of the face of passenger 102. In one preferred embodiment, the shade 116 may be sized to extend over the eyes of passenger 102, to provide substantial shielding or blocking of light from the surrounding environment. The shade 116 may be sized to both fully conceal the head support assembly 112 from nearby people and to fully shield the eyes of passenger 102 from the surrounding environment. Thus, the shade 116 may help passenger 102 with falling or staying asleep, or at least otherwise resting and/or relaxing. Additionally, the hood 114 may include at least one opening 118 for allowing a portion of the head support assembly 112 to pass through.

The head support assembly 112 may be configured to provide support to the head of passenger 102, which may assist with maintaining the head in a substantially upright position. In some embodiments, head support assembly 112 may include a head segment 120 and a seat segment 122. The head segment 120 may be generally adapted to contact and extend around the forehead of the passenger 102. For example, in some instances the head segment 120 may extend around the forehead and around each side of the head of passenger 102 and pass from the inside of the hood 114 through an opening 118 on each respective side of the hood 114 to the outside of the hood 114. In some embodiments, the head segment 120 of the head support assembly 112 may connect on each side of the hood 114, and thus passenger 102, to a seat segment 122, using one or more segment fasteners 124. The seat segment 122 may be sized or configured to extend around the headrest 106 of the seat 104, in order to provide a way of supporting or anchoring the head segment 120 to the headrest 106. The head support assembly 112 may thus provide support to the head of passenger 102 in order to prevent significant movement in both forward/backward directions as well as in side-to-side directions. In some embodiments, the head support assembly 112 may include multiple head straps which may be separately positionable for maximizing support and comfort. For example, the head support assembly 112 may include a first strap that is for positioning around the forehead and a second strap that is for positioning around the chin or lower portion of the face of the passenger 102.

FIG. 2 shows a top-down view of the passenger 102 wearing the head support system 100. In this alternative view, it can be seen how the head support assembly 112 may fully extend around the headrest 106 to provide support to the head of the passenger 102 who may be sitting in an upright position. As illustrated in FIG. 2, the head support assembly 112 may include both the head segment 120 and the seat segment 122. As previously discussed with respect to FIG. 1, the head segment 120 may be generally adapted to extend around the forehead of the passenger 102, underneath or inside of the hood 114. The seat segment 122 of the head support assembly 112 may be generally sized to extend around the headrest 106 of seat 104 and to connect with the head segment 120. In some embodiments, the head support assembly 112 may include two devices, such as segment fasteners 124, for fastening or buckling the two ends of the head segment 120 to the two ends of the seat segment 122. In some instances, the dimensions and proportions of the head segment 120 and seat segment 122 of the head support assembly 112 may be such that each of the segment fasteners 124 may be positioned on the sides of the head of passenger 102. However, in some embodiments, the head support assembly 112 may include only one segment fastener 124 for detachably connecting the head segment 120 and the seat segment 122. In such embodiments, the head support assembly 112 may also include a fixed connector, which may permanently connect the second ends of each of the head segment 120 and the seat segment 122.

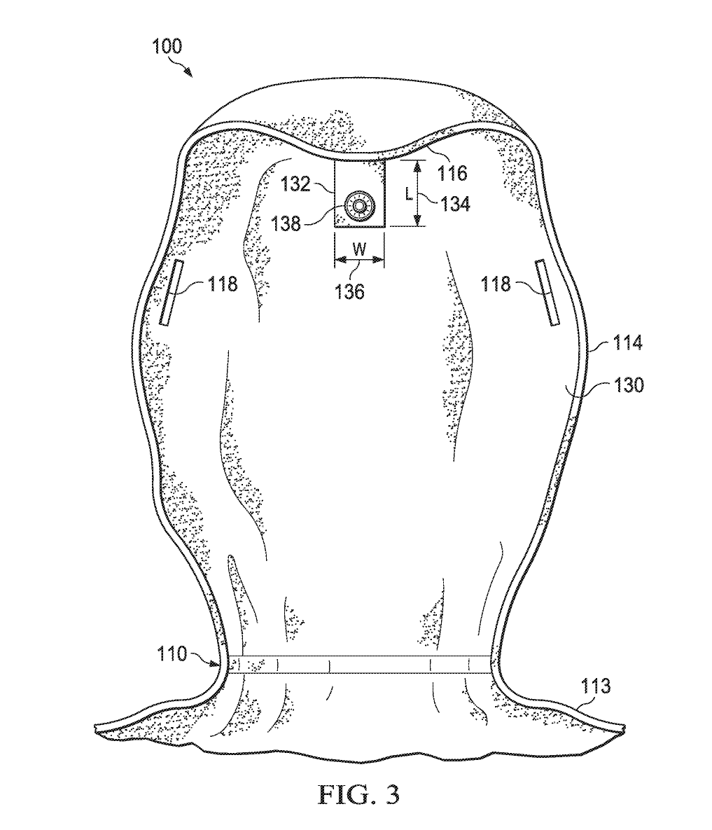

Referring now to FIG. 3, a view of the interior of an example embodiment of hood 114 from a front view of head support garment 110 is shown. Thus, in this figure, the hood interior 130 can be viewed. While the overall head support garment 110 may be formed from one or more of any number of possible materials, in some embodiments, it may be ideal for the hood interior 130 to include a soft, non-abrasive material, which may be comfortable when in contact with the head or face of passenger 102. Therefore, in some embodiments, the hood interior 130 may include a liner made from a soft cloth, such as cotton, polyester, or other soft material for providing a surface gentle to the skin of passenger 102. Also shown in FIG. 3 are the one or more opening(s) 118 of the hood 114, which may allow one or more portions of the head support assembly 112 to pass between the spaces inside and outside of the hood 114.

Still referring primarily to FIG. 3, in some embodiments, the hood 114 may include an attachment mechanism, such as hood connector 132, for providing an attachment point for the head support assembly 112. For example, the portion of the head segment 120 of head support assembly 112 that is adapted to be in contact with the forehead of passenger 102, may have a complementary attachment mechanism for connecting the head segment 120 to the hood connector 132. In some embodiments, the hood connector 132 may include a hood fastener 138, which may pair with a fastener included on the head segment 120. Such a hood fastener 138 may be in the form of hook and loop fasteners, such as VELCRO fasteners, a button, a snap, a releasable adhesive, or any other form of fastening apparatus. While the hood fastener 138 may offer releasable fastening of the hood connector 132 to the head segment 120, in some embodiments, the head segment 120 may be permanently affixed to the hood connector 132. Furthermore, in some alternative embodiments, the hood connector 132 may be omitted, and the head segment 120 of the head support assembly 112 may be sized and/or shaped to be directly connected or affixed to the underside of the shade 116 of the hood 114.

In some embodiments, the hood connector 132 may be in the form of a piece of material, such as fabric, that extends downward from the under surface of the shade 116 of the hood 114. For example, in some instances, the hood connector 132 may a rectangular-shaped piece of fabric, such as nylon or polyester, which may include a downward-extending length 134 of approximately 1 inch to 4 inches and a width 136 of approximately 0.5 inch to 3 inches. However, suitable other lengths 134 and/or widths 136 of the hood connector 132, as well as other materials, may also be used as appropriate.

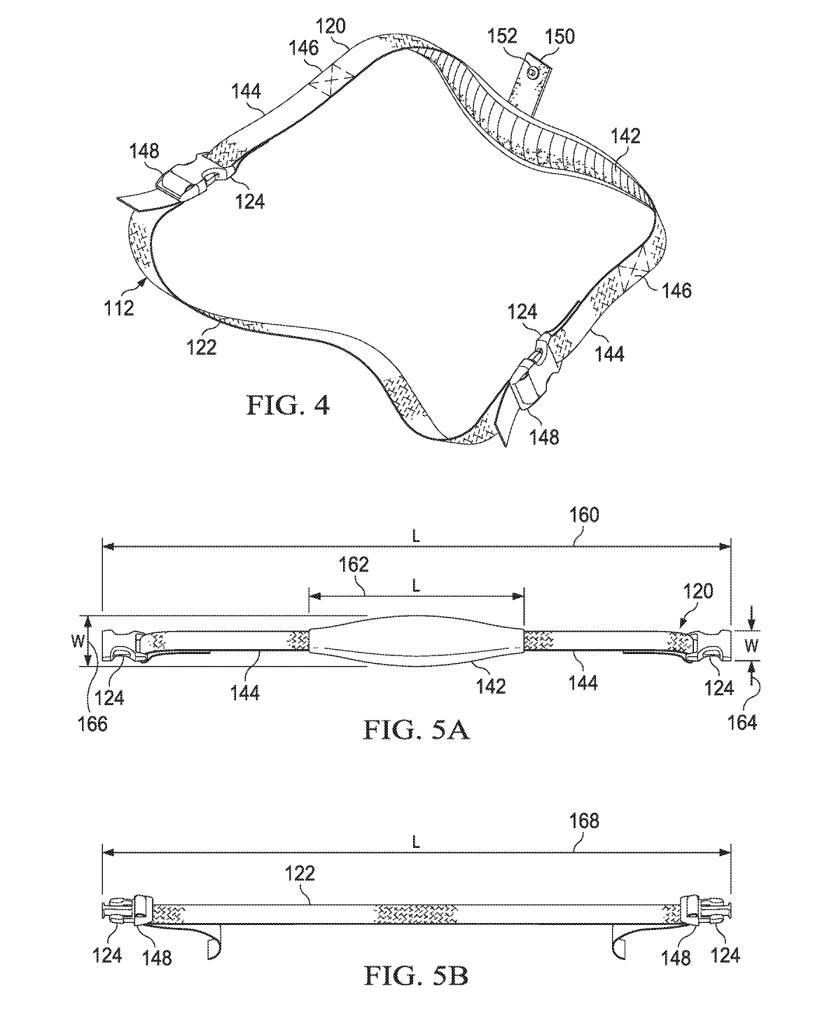

FIG. 4 provides a perspective view of an example illustrative embodiment of a head support assembly 112, shown separate from the other components of the head support system 100. As previously discussed, the head support assembly 112 may include a head segment 120 and a seat segment 122. In some embodiments, the head segment 120 and the seat segment 122 may be connected using two segment fasteners 124, with one segment fastener 124 connecting a first end of the head segment 120 to a first end of the seat segment 122 and another segment fastener 124 connecting a second end of the head segment 120 to a second end of the seat segment 122. The segment fastener(s) 124 may include any one of a variety of fastening mechanisms. For example, the segment fastener(s) 124 may be in the form of a buckle-type fastener for detachably fastening the head segment 120 to the seat segment 122. Alternatively or additionally, the segment fastener(s) 124 may include buttons, zippers, stitching, VELCRO fasteners, or virtually any other form of fastening means.

As depicted in FIG. 4, the head segment 120 may include a pad 142, which may be generally adapted to be placed against the forehead of a person, such as passenger 102. The head segment 120 may also include one or more side portion(s) 144, which may substantially make up the remaining portion of the head segment 120. The pad 142 may be connected on each side to a side portion 144 by a pad connection 146. Thus, in some embodiments, each of the side portions 144 may terminate on one end at a pad connection 146 and at the other end at a segment fastener 124. While the side portion(s) 144 of the head segment 120 may be formed from a relatively elastic material, the pad connection(s) 146 may be formed of a relatively stiff and non-elastic material. Depending on the particular embodiment, the seat segment 122 of the head support assembly 112 may also be made from either a stretchable, elastic-type material, or in the alternative, a substantially stiff material. In either case, in some embodiments, the length of the seat segment 122, and thus the overall length of the head support assembly 112, may be adjusted using one or more strap adjuster(s) 148.

Still referring to FIG. 4, the head support assembly 112 may include an apparatus for connecting the head support assembly 112 to the hood 114, and thus the other portions of the head support system 100. For example, in some instances, the head segment 120 of the head support assembly 112 may include a segment of material that extends from a top edge of the pad 142, such as support connector 150, for connecting to a connection apparatus on the hood 114, such as hood connector 132 of FIG. 3. Additionally, in some embodiments, the support connector 150 may be configured to attach directly to a portion of the hood 114, such as an interior underside of shade 116, without the need for hood connector 132. In either such embodiment, the support connector 150 may include a fastening means, such as support fastener 152, which in some embodiments may be a button, snap, VELCRO fastener, adhesive, Zipper, or any other type of fastener. Thus, depending on the specific embodiment, either or both of the hood connector 132 or the underside of the shade 116 may include a connection point, such as hood fastener 138, which may be compatible with the support connector 150.

Referring now primarily to FIG. 5A, an example embodiment of head segment 120 of head support assembly 112 is shown. The sizes and dimensions of the overall head segment 120 as well as the individual components, such as the pad 142 and side portions 144, may vary. For example, the head segment 120 may be available in a variety of sizes, which in some instances, may correspond to different sizes of the head support garment 110. However, in some embodiments, the head segment 120 may be provided in a one-size-fits-all version, which may be sized and adapted to fit the substantial majority of the population of passengers. For example, in some embodiments of a one-size-fits-all version, the head segment 120 may have a head segment length 160 ranging from approximately 6 inches to 24 inches. In some embodiments, the head segment length 160 may be approximately 16 inches. As part of that overall head segment length 160, a pad length 162 of the pad 142 may be included. For example, the pad length 162 may range from approximately 2 inches to 14 inches, and in some embodiments may be about 10 inches. Additionally, the width of the various portions of the head segment 120 may vary, however in some embodiments, the side portions 144 may have a side portion width 164 ranging from approximately 0.5 inch to 3 inches, and the pad 142 may have a pad width 166 ranging from approximately 1 inch to 5 inches. For example, in some example embodiments, the side portion width 164 may be approximately 1.5 inches, and the pad width 166 may be approximately 3.25 inches.

The pad 142 may be included in a variety of shapes, sizes, materials, and designs. For example, in some embodiments, the pad 142 may have a contoured shape, which may include a center region that is wider than the two narrower peripheral regions. The pad 142 may also be provided in substantially rectangular, oval, trapezoidal, or any other shape suitable for providing a comfortable interface with the forehead of a passenger. The pad 142 may be made from a variety of materials, including neoprene, foam, memory foam-type material, cotton, polyester, nylon, or any other suitable material. For example, in some embodiments, the pad 142 may include a cotton outer layer enclosing an inner, pillow-like filler material. In some embodiments, an inner, pillow-like cushion material may be contained in an outer, removable and washable cover. For example, the outer cover of the pad 142 may be installed around the inner cushion material and sealed with a zipper or other sealing device. In such embodiments, the outer cover of the pad 142 may thus be periodically removed and washed for sanitary and appearance purposes. In some embodiments, the pad 142 may also include at least a portion of the passenger-facing surface that is for providing some level of grip to the passenger's forehead, to reduce or prevent the pad 142 from moving around or becoming displaced. Additionally, the pad 142 may be available in a variety of different colors or include different pictures or characters sown or printed as part of the material of the pad 142. For example, the pad 142 may include characters or animal figures that may be of particular familiarity or interest to children.

Referring now to FIG. 5B, an example embodiment of seat segment 122 of head support assembly 112 is shown. As is the case with the head segment 120 of the head support assembly 112, the sizes and dimensions of the seat segment 122 may vary. Once again, the seat segment 122 may be available in a variety of sizes, which may correspond to different sizes of the head support garment 110. The seat segment 122 may also be provided in a uniform size version, which may be sized to fit the majority of passengers. For example, in some embodiments, the seat segment 122 may have a seat segment length 168, which extends from the segment fastener 124 at one end of the seat segment 122 to the segment fastener 124 at the other end of the seat segment 122. In such embodiments, the seat segment length 168 may range from a maximum length of approximately 20 inches to approximately 60 inches. For example, the seat segment length 168 may have a maximum length of approximately 40 inches. Regardless of the maximum length of the seat segment length 168, the one or more strap adjuster(s) 148 may be used to adjust the seat segment length 168, depending on the size of the passenger's head as well as the distance around a seatback or headrest.

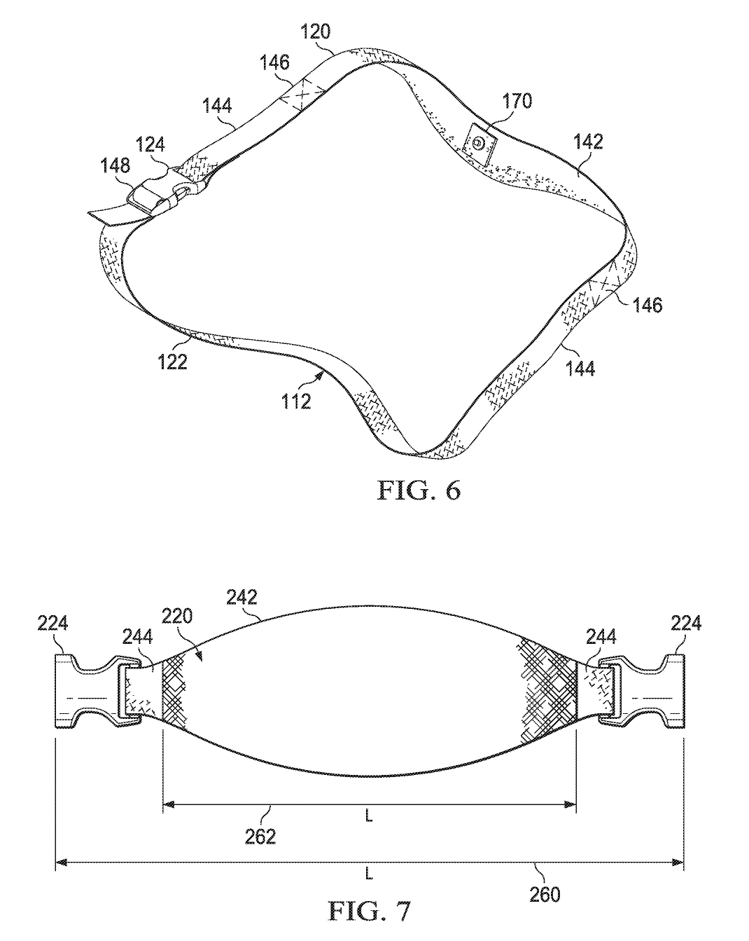

FIG. 6 shows another example embodiment of a head support assembly 112 for use with the head support system 100. In this illustrative embodiment, the head support assembly 112 may include a head segment 120 which may be permanently affixed at one end to a seat segment 122. For example, in some embodiments, the head segment 120 may include a pad 142 and a single side portion 144. One side of the pad 142 may be affixed to the side portion 144 by way of a first pad connection 146, and the second side of the pad 142 may be permanently affixed to one end of the seat segment 122 by means of a second pad connection 146. As a result, some embodiments of the head support assembly 112 may necessitate only one segment fastener 124 for releasably coupling the head segment 120 to the seat segment 122. Similarly, some embodiments of the head support assembly 112, may include only one strap adjuster 148, for varying the length of the seat segment 122. Additionally, the example embodiment of FIG. 6 is shown with a connector, such as pad connector 170, on an outward-facing side, or non-forehead-facing side, of the pad 142 for connecting to the hood 114 of the head support system 100.

FIG. 7 shows an additional example embodiment of a head segment 220, which may be a portion of the head support assembly 112 of FIG. 1. The head segment 220 of FIG. 7 may be similar to head segments shown in the previous illustrative examples, such as head segment 120 of FIG. 5A. For example, the head segment 220 may include a pad 242, side portions 244, and segment fasteners 224. However, as illustrated in FIG. 7, the head segment 220 may include side portions 244 that make up a rather small portion of the overall head segment 220, as compared to the side portions 144 of the head segment 120. Thus, the pad 242 may have a pad length 262 that makes up a majority of a head segment length 260. For example, in some embodiments, the overall head segment length 260 may range from approximately 5 inches to 20 inches, while the pad length 262 may range from approximately 4 inches to 18 inches. Due to the shorter side portions 244, the overall head segment length 260 of head segment 220 may be less than the head segment length 160 of the head segment 120. As a result, in some cases, the shorter length of head segment 220 may cause the segment fasteners 224 to be closer to the side of the head of passenger 104, rather than positioned more adjacent the headrest 106. This may be desirable in some cases, as the segment fasteners 224 may be more easily reached for fastening and unfastening by the passenger 102.

In operation, the passenger 102 may wear and benefit from the head support system 100 in a variety of different transportation contexts. For example, in one scenario, the passenger 102 may be sitting in a seat on an airplane during a long overnight flight and may wish to sleep for a period of time. Thus, the passenger 102 may easily apply the head support garment 110 to themselves, such as by wrapping themselves in the body of the garment, in the case of a scarf or shawl, or dressing in the garment, in the case of a hooded sweatshirt, jacket, or cardigan. Either before or after dressing in the head support garment 110, the passenger 102 may apply the head support assembly 112 to the head support garment 110. For example, portions of the head support assembly 112, more specifically the side portions 144 of the head segment 120, may be passed through the openings 118 of the hood 114 of the head support garment 110. The passenger 102 may then wrap the remaining portion of the head support assembly 112, for example the seat segment 122, around the headrest or seatback, followed by connecting the seat segment 122 to the head segment 120. For example, the passenger 102 may fasten a first end of the head segment 120 to a first end of the seat segment 122 on one side of his or her head using one of the segment fasteners 124. The passenger 102 may then wrap the body of the seat segment, or strap portion, around the back of the headrest or seatback cushion, followed by fastening the second end of the seat segment 122 to the second end of the head segment 120 on the other side of his or her head using the other segment fastener 124. Importantly, the dimensions of the head segment 120 and seat segment 122 of the head support assembly 112 may be such that the segment fasteners 124 are positioned outside of the hood 114 and in close proximity to the back of the passenger's head or sides of the headrest or seat cushion, to avoid discomfort to the sides of the passenger's head.

The passenger 102 may then make adjustments to the head support assembly 112 as necessary to ensure a proper fit for providing support and comfort. For example, the passenger 102 will likely need to tighten the head support assembly 112 by adjusting the length of the seat segment 122 using the one or more strap adjuster(s) 148. The passenger 102 may then make additional adjustments to the position of the pad 142 or segments of the head support assembly 112 as necessary or desired.

The systems, apparatuses, and methods described herein may provide significant advantages. For example, as disclosed herein, the various embodiments of the head support system 100 may offer a hooded head support device that also may provide adequate coverage from external light. Thus, the embodiments of the head support system 100 disclosed herein may provide dual benefits for assisting a passenger achieve restful sleep or relaxation. Importantly, the head support system 100 may successfully limit the amount of forward-and-backward as well as side-to-side head movement of a passenger, in order to provide the passenger with a high degree of comfort while trying to sleep or rest. However, it is important to recognize that the head support system 100 may allow for some degree of motion, as fixing a passenger's head in a single position can, as time passes, also lead to discomfort. Thus, the head support assembly 112 of the head support system 100 is capable of providing a cushioned and comfortable fit to the passenger, while the flexible or elastic-like portions may allow for turbulence or swaying during travel to be absorbed with minimal discomfort to the passenger. Therefore, prolonged pressure to portions of a user's face or head, such as the case with the use of head support devices employing chin straps, may be avoided. Additionally, by allowing some degree of movement, the head support assembly 112 may be less likely to become distorted and displaced from an appropriate position around the user's head and applicable seatback, thus further avoiding possible causes for discomfort.

Additionally, the head support system 100 offers comfortable use to the passenger, as well as may offer a significant range of adjustability to suit the needs of people of different ages, sizes, and body proportions. The head support system 100 also provides a quick and easy-to-operate way for the user to fasten the head support assembly 112 of the head support system 100 to the headrest or seatback of substantially any standard commercial travel seat. Furthermore, the head support system 100 offers a cleverly-disguised way to provide head support. The head support system 100 may also be convenient for travel, particularly because, at least with some embodiments, the head support assembly 112 may be removed from the head support garment 110, so that the head support garment 110 may be otherwise worn in its regular capacity as a hooded jacket, sweatshirt, cardigan, scarf, shawl, or other form of garment. Additionally, in some embodiments, the head support assembly 112 may be easily stored within the head support garment 110, such as within a pocket or compartment on the interior or exterior of the head support garment 110.

While shown in a few illustrative embodiments, a person having ordinary skill in the art will recognize that the systems, apparatuses, and methods described herein are susceptible to various changes and modifications. Moreover, descriptions of various alternatives using terms such as “or” do not require mutual exclusivity unless clearly required by the context, and the indefinite articles “a” or “an” do not limit the subject to a single instance unless clearly required by the context. Components may be also be combined or eliminated in various configurations for purposes of sale, manufacture, assembly, or use. For example, in some configurations the head support garment 110, the head support assembly 112, or both may be eliminated or separated from other components for manufacture or sale.

The appended claims set forth novel and inventive aspects of the subject matter described above, but the claims may also encompass additional subject matter not specifically recited in detail. For example, certain features, elements, or aspects may be omitted from the claims if not necessary to distinguish the novel and inventive features from what is already known to a person having ordinary skill in the art. Features, elements, and aspects described herein may also be combined or replaced by alternative features serving the same, equivalent, or similar purpose without departing from the scope of the invention defined by the appended claims.

What is claimed is:

1. A head support system, comprising:
a head covering having a hood; and
a support device comprising:
a cushion member adapted to be placed in contact with the head of a person, and
a securing member adapted to releasably secure the cushion member to the head covering;
wherein the head covering is sized to extend over the forehead and eyes of the person and to conceal the cushion member.

2. The head support system of claim 1, wherein the securing member comprises a single strap and a fastener.

3. The head support system of claim 1, wherein the cushion member comprises:
a first strap portion;
a second strap portion; and
a cushion positioned between the first strap portion and the second strap portion.

4. The head support system of claim 3, wherein the first strap portion and the second strap portion each comprises an elastic material.

5. The head support system of claim 1, wherein the securing member comprises:
a strap;
a first fastener;
a second fastener; and
an adjuster for adjusting a length of a portion of the strap.

6. The head support system of claim 2, wherein the fastener comprises a releasable buckle.

7. The head support system of claim 1, wherein the hood of the head covering comprises:
a first opening formed in a first side of the hood; and
a second opening formed in a second side of the hood;
wherein each of the first opening and second opening is sized to allow a portion of the securing member to pass from the exterior of the hood to the interior of the hood.

8. The head support system of claim 7, wherein each of the first opening and the second opening has a length ranging from approximately 0.5 inches to 3 inches.

9. The head support system of claim 2, wherein the strap has a width ranging from approximately 0.5 inches to 2.5 inches.

10. The head support system of claim 5, wherein the strap comprises an elastic portion.

11. The head support system of claim 1, wherein the securing member has an adjustable length and a maximum length of approximately 60 inches.

12. The head support system of claim 1, wherein the hood further comprises a first attachment member for releasably attaching to the support device.

13. The head support system of claim 12, wherein the support device further comprises a second attachment member for releasably attaching to the first attachment member.

14. A head support apparatus, comprising:
a head covering; and
a head support assembly configured to be positioned around a head of a passenger, comprising:
a head segment, and
a support segment;
wherein the head segment is sized so that a substantial portion of the head segment is covered by the head covering when worn on the passenger and hidden from the view of bystanders.

15. The head support apparatus of claim 14, wherein:
the head segment comprises:
a first strap portion,
a second strap portion,
a cushion, and
a first portion of a fastening mechanism; and
the support segment comprises:
a third strap portion, and
a second portion of the fastening mechanism;
wherein the first portion of the fastening mechanism is configured to be releasably secured to the second portion of the fastening mechanism.

16. The head support apparatus of claim 15, wherein the first strap portion and the second strap portion each comprise an elastic portion.

17. The head support apparatus of claim 15, wherein the third strap portion of the support segment has a length that connects a first end of the first strap portion and a first end of the second strap portion.

18. The head support apparatus of claim 14, wherein the support segment further comprises an adjustment mechanism for varying a length of the support segment.

19. The head support apparatus of claim 15, wherein the head segment further comprises an attachment device positioned on the cushion and adapted to releasably attach to the head covering.

20. A head support apparatus, comprising:
a head covering comprising a hood having a first opening on a first side and a second opening on a second side;
a support strap adapted to be positioned around a portion of a head of a person and to pass through the first opening and the second opening of the head covering;
wherein the hood comprises a shield portion adapted to block light from a surrounding environment from reaching the eyes of the person.
